(19) United States
(12) Patent Application Publication
(10) Pub. No.: US 2016/0146628 A1
(43) Pub. Date: May 26, 2016

(54) AVN TERMINAL AND CONTROL METHOD THEREOF

(71) Applicant: Hyundai Motor Company, Seoul (KR)

(72) Inventor: Yeon Ji Kim, Seoul (KR)

(21) Appl. No.: 14/853,230

(22) Filed: Sep. 14, 2015

(30) Foreign Application Priority Data
Nov. 21, 2014 (KR) 10-2014-0163182

(51) Int. Cl. G01C 21/36; G01S 19/13

(52) U.S. Cl. CPC G01C 21/3697; G01S 19/13

(57) ABSTRACT

An audio-video-navigation (AVN) terminal includes: a display; a position information reception unit configured to receive position information of a vehicle including a current position of the vehicle; and a controller configured to display, via the display, traffic laws of an area including the current position of the vehicle in a language set of the AVN terminal when the language set of the AVN terminal does not correspond to a predefined language related to the area.

### CROSS-REFERENCE TO RELATED APPLICATION

This application claims priority to and the benefit of Korean Patent Application No. 10-2014-0163182, filed on Nov. 21, 2014, which is hereby incorporated by reference as if fully set forth herein.

### BACKGROUND

1. Technical Field

The present disclosure relates to an audio-video-navigation (AVN) terminal and a control method thereof and, more particularly, to an AVN terminal and a control method thereof having improved user convenience.

2. Discussion of the Related Art

Recent increased development of electronic control technology has allowed for a variety of vehicular devices, which have conventionally been mechanically operated, to be electrically driven for driver convenience, driving safety, and the like. For instance, an audio-video-navigation (AVN) terminal may be incorporated in a vehicle to provide audio, video, and navigation functions. In addition, the AVN terminal may perform communication with a telematics unit via controller area network (CAN) communication, or may be integrally equipped with a telematics unit. In addition, the AVN terminal may be equipped with a display to provide visual information to a user. Generally, the AVN terminal provides a function for guiding a user to a destination.

Conventionally, when a vehicle is driven from one area to another area, AVN terminals have been used to provide traffic information of the destination area. However, there is a need to provide an AVN terminal for better user convenience.

### SUMMARY

Accordingly, the present disclosure is directed to an AVN terminal and a control method thereof that substantially obviate one or more problems due to limitations and disadvantages of the related art.

An object of the present disclosure is to provide an AVN terminal that provides a user with the traffic laws of an area including a current position of a vehicle in a language set in the AVN terminal when the set language differs from a pre-defined language that is used in the corresponding area and a control method thereof. Additional advantages, objects, and features of the present disclosure will be set forth in part in the description which follows and in part will become apparent to those having ordinary skill in the art upon examination of the following or may be learned from practice of the disclosed embodiments. The objectives and other advantages of the present disclosure may be realized and attained by the structure particularly pointed out in the written description and claims hereof as well as the appended drawings.

To achieve these objects and other advantages and in accordance with the purpose of the present disclosure, as embodied and broadly described herein, the present disclosure provides an audio-video-navigation (AVN) terminal including: a display; a position information reception unit configured to receive position information of a vehicle including a current position of the vehicle; and a controller configured to display, via the display, traffic laws of an area including the current position of the vehicle in a language set of the AVN terminal when the language set of the AVN terminal does not correspond to a predefined language related to the area.

The position information reception unit may be further configured to receive global positioning system (GPS) position information, and the controller may be further configured to determine the current position of the vehicle based on the GPS position information received by the position information reception unit.

The predefined language related to the area including the current position of the vehicle may include a plurality of languages, and the controller may be further configured to determine whether the language set of the AVN terminal corresponds to any of the plurality of languages.

The controller may be further configured to update the traffic laws of the area, written in at least one language providable by the AVN terminal, received from an external telematics center.

The controller may be further configured to update the traffic laws of the area in real-time or at a predetermined time interval.

The controller may be further configured to display, via the display, the traffic laws of the area in a pop-up window form.

The controller may be further configured to display, via the display, a pop-up window requesting a passenger to provide the traffic laws of the area and to display, via the display, the traffic laws of the area when the passenger agrees to provide the traffic laws.

The controller may be further configured to display, via the display, area characteristic information of the area in the language set of the AVN terminal.

The area characteristic information may include at least one of: weather information, tourism information, disaster information, shopping information, and promotion information related to the area.

The controller may be further configured to display, via the display, a still image or moving image corresponding to at least one of: weather information, tourism information, disaster information, shopping information, and promotion information related to the area.

The AVN terminal may further include an audio module, and the controller may be further configured to audibly output, via the audio module, the traffic laws of the area in the language set of the AVN terminal.

The controller may be further configured to audibly output, via the audio module, the area characteristic information of the area in the language set of the AVN terminal.

The controller may be further configured to display, via the display, a still image or moving image corresponding to the traffic laws.

Furthermore, according to embodiments of the present disclosure, a control method of an AVN terminal includes: receiving position information of a vehicle regarding a current position of the vehicle; and displaying traffic laws of an area including the current position of the vehicle in a language set of the AVN terminal when the language set of the AVN terminal does not correspond to a predefined language related to the area.

The receiving of the position information may include: receiving global positioning system (GPS) position information, and determining the current position of the vehicle based on the GPS position information.

The predefined language related to the area including the current position of the vehicle may include a plurality of languages, and the displaying of the traffic laws of the area may include determining whether the language set of the AVN terminal corresponds to any of the plurality of languages.

The method may further include updating the traffic laws of the area, written in at least one language providable by the AVN terminal, received from an external telematics center.

The updating of the traffic laws of the area may include updating the traffic laws of the area in real-time or at a predetermined time interval.

The method may further include displaying the traffic laws of the area in a pop-up window form.

The displaying of the traffic laws of the area may include: displaying a pop-up window requesting a passenger to provide the traffic laws of the area, and displaying the traffic laws of the area when the passenger agrees to provide the traffic laws.

Furthermore, according to embodiments of the present disclosure, a non-transitory computer readable medium containing program instructions for performing a control method of an AVN terminal includes: program instructions that receive position information of a vehicle regarding a current position of the vehicle; and program instructions that display traffic laws of an area including the current position of the vehicle in a language set of the AVN terminal when the language set of the AVN terminal does not correspond to a predefined language related to the area.

It is to be understood that both the foregoing general description and the following detailed description of the present disclosure are exemplary and explanatory and are intended to provide further explanation of the disclosed embodiments as claimed.

### BRIEF DESCRIPTION OF THE DRAWINGS

The accompanying drawings, which are included to provide a further understanding of the present disclosure and are incorporated in and constitute a part of this application, illustrate embodiments of the disclosure and together with the description serve to explain the principle of the disclosure. In the drawings:

FIG. 1 is a block diagram of an AVN terminal according to embodiments of the present disclosure;

FIGS. 2 to 4 are views showing an operation sequence of the AVN terminal according to embodiments of the present disclosure; and

FIG. 5 is a flowchart showing a control method of an AVN terminal according to embodiments of the present disclosure.

### DETAILED DESCRIPTION OF THE EMBODIMENTS

Hereinafter, reference will now be made in detail to the embodiments of the present disclosure, examples of which are illustrated in the accompanying drawings. In the drawings, the same or similar elements are denoted by the same reference numerals even though they are depicted in different drawings, and a detailed description of the same or similar elements will be omitted. The suffixes “module” and “unit” of elements herein are used for convenience of description and thus can be used interchangeably and do not have any distinguishable meanings or functions. In addition, in the following description of the embodiments disclosed herein, a detailed description of related known technologies will be omitted when it may make the subject matter of the embodiments disclosed herein rather unclear. In addition, the accompanying drawings have been made only for a better understanding of the embodiments disclosed herein and are not intended to limit technical ideas disclosed herein, and it should be understood that the accompanying drawings are intended to encompass all modifications, equivalents and substitutions included in the sprit and scope of the present disclosure,

The terms including “first,” “second,” and the like may be used to describe various elements, but the elements are not limited by the terms. The terms, if any, are used for distinguishing between one element and other elements.

It will be understood that when one element is referred to as being “connected to” or “accessed by” another element, one element may be “connected to” or “accessed by” another element via a further element although one element may be directly connected to or directly accessed by another element. On the other hand, it will be understood that when one element is referred to as being “directly connected to” or “directly accessed by” another element, there is no component between the mentioned elements. The singular forms are intended to include the plural forms as well, unless the context clearly indicates otherwise.

The term “comprises” or “has” described herein should be interpreted not to exclude presence or addition possibility of characteristics, numbers, steps, operations, constituent elements, parts or combinations thereof described in the specification but to designate presence of one or more other characteristics, numbers, steps, operations, constituent elements, parts or combinations thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Furthermore, the controller of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

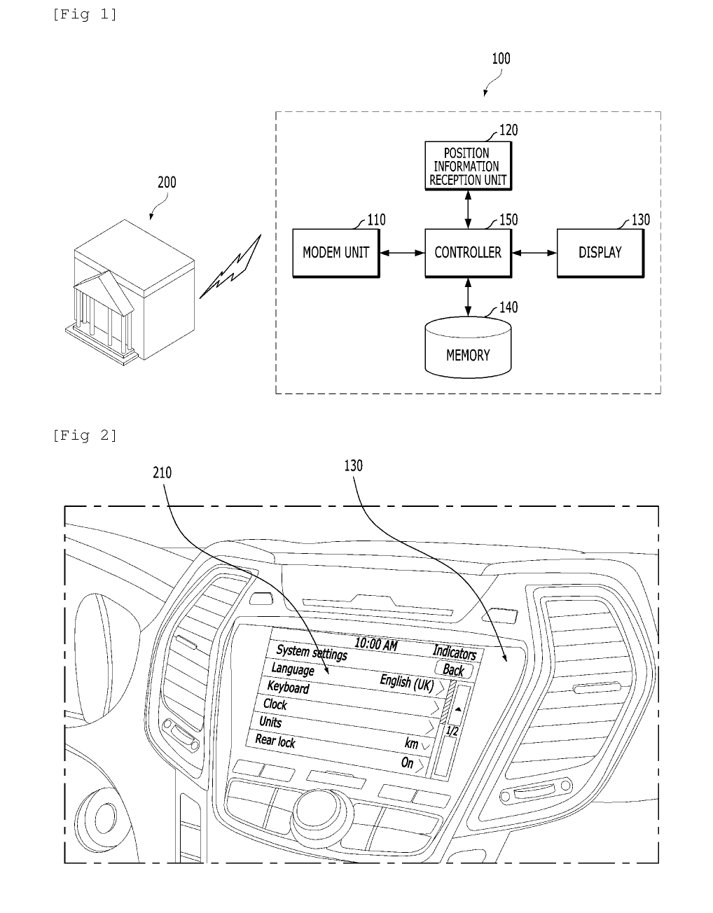

Referring now to the disclosed embodiments, FIG. 1 is a block diagram of an AVN terminal according to embodiments of the present disclosure. As shown in FIG. 1, the AVN terminal 100 may include a modem unit 110, a position information reception unit 120, a display 130, a memory 140, and a controller 150.

While the AVN terminal 100 is described herein as including the modem unit 110 and the position information reception unit 120, the AVN terminal 100 may be provided separately from a telematics unit (not shown) including the modem unit 110 and the position information reception unit 120 to perform communication with the telematics unit (not shown) via in-vehicle communication, such as controller area network (CAN) communication. In addition, the components shown in FIG. 1 may not be necessary to construct the AVN terminal 100 and the AVN terminal 100 as described herein may include a different number of components than the aforementioned components. The AVN terminal 100 generally includes the display 130 disposed at a front interior region of a vehicle. In addition, the AVN terminal 100 provides audio, video, and navigation functions.

The modem unit 110 may include one or more modules to enable wireless communication between the AVN terminal 100 and a wireless communication system, between the AVN terminal 100 and another AVN terminal, or between the AVN terminal 100 and an external center. In addition, the modem unit 110 may include one or more modules to connect the AVN terminal 100 to one or more networks. While the modem unit 110 and the position information reception unit 120 have been described separately herein, the modem unit 110 and the position information reception unit 120 may be incorporated in a telematics unit (not shown).

The modem unit 110 may perform communication with a telematics center 200. Generally, the modem unit 110 may perform communication with the telematics center 200 using wireless communication. The modem unit 110 may transmit and receive radio signals to and from at least one of a base station, an external terminal, and the telematics center 200 via a mobile communication network that is constructed according to technical standards for mobile communication or communication methods (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), and the like). The radio signals may include various types of data based on transmission/reception of voice call signals, video call signals, and letters/multimedia messages.

The position information reception unit 120 serves to acquire a position (or current position) of the AVN terminal 100. For example, a position of the AVN terminal 100 may be acquired as the position information reception unit 120 receives singles transmitted from GPS satellites. Meanwhile, the AVN terminal 100 may have Wi-FI, Bluetooth, and Wi-Fi direct functions.

The display 130 may include at least one selected from among a liquid crystal display (LCD), a thin film transistor-liquid crystal display (TFT-LCD), an organic light emitting diode (OLED), a flexible display, a three-dimensional (3D) display, e-ink display, and the like. In addition, two or more displays 130 may be present in the AVN terminal 100. In this case, the mobile terminal 100 may include plural displays that are spaced apart from one another or integrally arranged in a single plane, or are arranged respectively in different planes. The display 130 may include a touch sensor to sense a touch to the display 130 so as to receive a control command in a touch manner. As such, upon occurrence of a touch to the display 130, the touch sensor may sense the touch and the controller 150 may generate a control command corresponding to the touch. Content input via touch may be letters or numerals, or menu items that may be indicated or designated in various modes

The memory 140 stores data to assist various functions of the AVN terminal 100. The memory 140 may store a number of applications that are driven in the AVN terminal 100, and data and commands for operation of the AVN terminal 100. At least some applications may be downloaded from an external center via wireless communication. In addition, at least some applications may be preinstalled in the AVN terminal 100 for basic functions of the AVN terminal 100. Meanwhile, the applications may be stored in the memory 140 and installed in the AVN terminal 100 so as to be driven by the controller 150 to perform operation (or functions) of the AVN terminal 100

The memory 140 may store programs to operate the controller 150, and temporarily store input/output data. The memory 140 may store data related to various patterns of vibrations and sound output upon input of a touch to a touchscreen. The memory 140 may include at least one storage medium selected from among a flash memory type memory, a hard disk type memory, a solid state disk (SSD) type memory, a silicon disk drive (SDD) type memory, a multimedia card micro type memory, a card type memory (for example, an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. The AVN terminal 100 may be operated in connection with a web storage that performs a storage function of the memory 140 in the Internet.

The controller 150 typically controls general operations of the AVN terminal 100 in addition to operations related to the applications. The controller 150 may process signals, data, and information input or output via the aforementioned components, or drive applications stored in the memory 140, thereby providing or processing information or functions suitable for a user. The controller 150 may receive current position information of the telematics terminal via the position information reception unit 120. The current position information may be acquired via GPS reception. The controller 150 displays content in a specific language via the display 130 of the AVN terminal 100.

When a language set in the AVN terminal 100 is not a predefined language related to an area including a current position of a vehicle, the controller 150 may determine that a passenger who is unfamiliar with the corresponding area rides in the vehicle. The corresponding area may include a “country”. For example, when a Dane changes a language preset in the AVN terminal 100, i.e., Korean into Danish, in Seoul of Korea, and Danish which is newly set in the AVN terminal 100 is not a predefined language in Korea, the controller 150 may determine that a passenger who is unfamiliar with Korea rides in the vehicle. In this case, the controller 150 may provide (i.e., display) the passenger with the traffic laws of an area (e.g., Korea) in a language set in the AVN terminal 100 (e.g., Danish) through the display 130.

The controller 150 may receive a current position of the vehicle through the position information reception unit 120. More specifically, the position information reception unit 120 may receive GPS position information from satellites. At this time, the controller 150 may determine a current position of the vehicle based on the GPS position information received by the position information reception unit 120.

In addition, the predefined language may include a plurality of languages. In this case, the controller 150 may determine whether the language set in the AVN terminal 100 is among the predefined languages.

In addition, the controller 150 may update the traffic laws of the corresponding area, which are written in at least one language that may be provided in the AVN terminal 100, received from an external telematics center. The controller 150 may receive the latest traffic laws of the corresponding area in real-time or at a predetermined time interval and store the same in the memory 140.

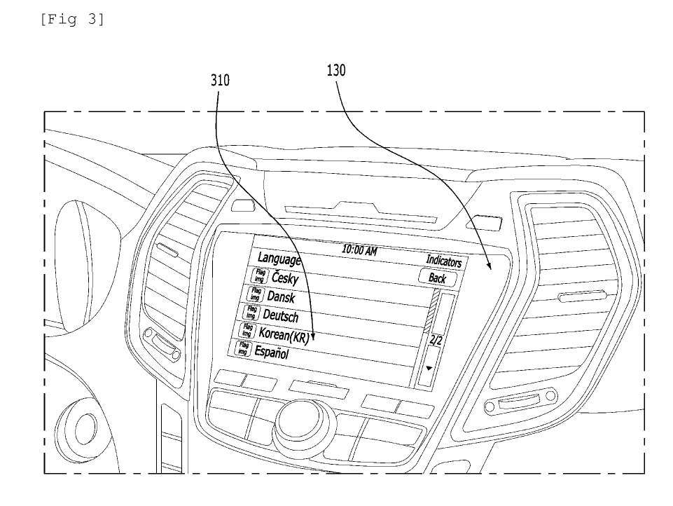

FIGS. 2 to 4 are views showing an operation sequence of the AVN terminal according to embodiments of the present disclosure.

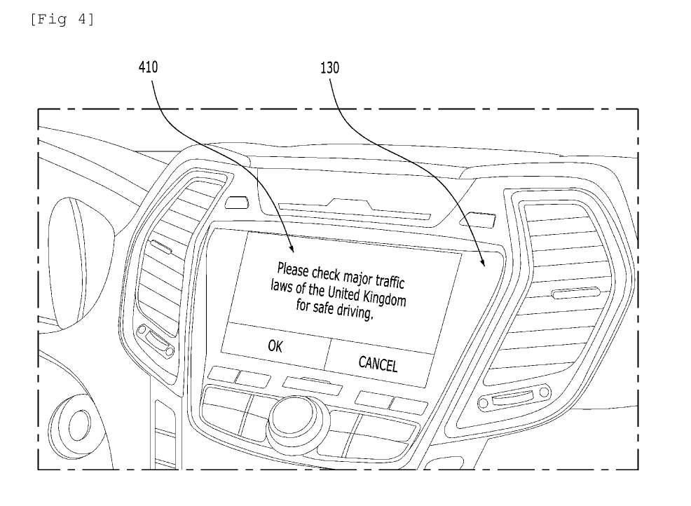

Referring to FIG. 2, assuming that a vehicle is currently in the United Kingdom, a current predefined language of the AVN terminal 100 in the United Kingdom is only “English (UK)”, and a passenger who attempts to change setting information of the AVN terminal 100 is Korean. The user may change a language of the AVN terminal 100. That is, the language currently set in the AVN terminal 100 (i.e., English (UK)) may be changed to various languages. The following description will refer to FIG. 3.

Referring to FIG. 3, the controller 150 may allow the user to change language setting. The passenger, i.e., a Korean passenger, may change the language set in the AVN terminal 100 into Korean. Thereby, a language of all information provided by the AVN terminal 100 may be changed into Korean. In this case, once a language of the AVN terminal 100 has been set to Korean, the controller 150 may provide the traffic laws of the corresponding area in the language (e.g., Korean) set in the AVN terminal 100 when the language set in the AVN terminal 100 is not the predefined language (e.g., English) related to the area including the current position of the vehicle (e.g., the United Kingdom).

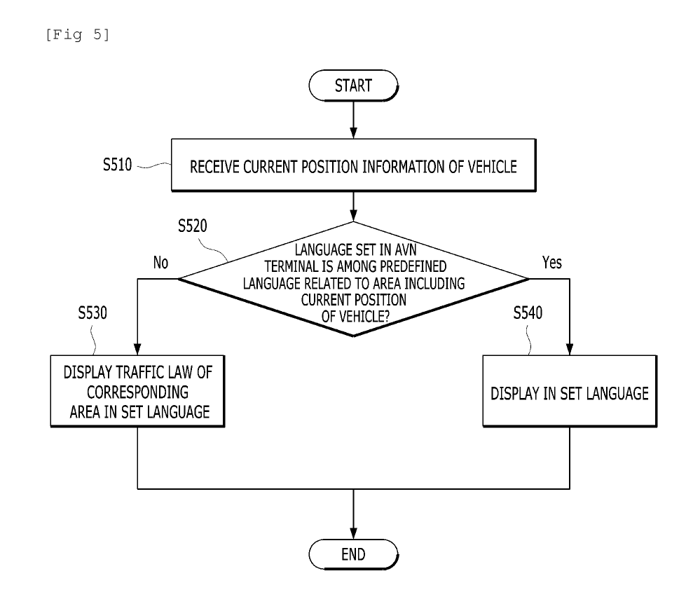

Notably, the controller 150 may provide (i.e., display) a pop-up window 410 that asks the passenger whether to provide the traffic laws of the area (e.g., the United Kingdom) as exemplarily shown in FIG. 5, and provide the traffic laws of the area (e.g., the United Kingdom) in Korean when the passenger agrees to provision of the traffic laws.

FIG. 5 is a flowchart showing a control method of an AVN terminal according to embodiments of the present disclosure.

First, the AVN terminal 100 receives current position information regarding a current position of the vehicle (S510). The AVN terminal 100 may determine the current position of the vehicle using a GPS receiver mounted therein.

Next, when a language set in the AVN terminal 100 is not a predefined language related to an area including the current position of the vehicle (S520), the AVN terminal 100 displays the traffic laws of the corresponding area in the language set in the AVN terminal (S530).

In addition, when a language set in the AVN terminal is a predefined language related to an area including the current position of the vehicle, the AVN terminal 100 changes a language of content displayed on the display of the AVN terminal 100 into the corresponding language (S540). There may be a plurality of predefined languages. The controller 150 may determine whether the language set in the terminal is among the predefined languages. In addition, the AVN terminal 100 may display (via the display 130) the traffic laws of the area in a pop-up window form. The AVN terminal 100 may provide (i.e., display) a pop-up window that asks the passenger whether or not to provide the traffic laws of the corresponding area and provide the passenger with the traffic laws of the area when the passenger agrees to provide the traffic laws.

In addition, the AVN terminal 100 may display area characteristic information of the corresponding area in a language set in the AVN terminal 100. The area characteristic information may include at least one of weather information, tourism information, disaster information, shopping information, and promotion information related to the area. Various other information may also be provided.

The AVN terminal 100 may also be equipped with an audio module. The AVN terminal 100 may additionally provide (i.e., audibly output) the traffic laws of the area in a language set in the terminal through the audio module. In this regard, the AVN terminal 100 may additionally provide (i.e., audibly output) area characteristic information of the corresponding area in a language set in the terminal through the audio module.

In addition, the AVN terminal 100 may additionally provide (i.e., display) a still image or moving image corresponding to the traffic laws on the display. Here, the AVN terminal 100 may display a still image or moving image corresponding to at least one of weather information, tourism information, disaster information, shopping information, and promotion information related to the area through the display.

The AVN terminal 100 may further display a guide for speed limits of main roads and driving regulation items. For example, the AVN terminal 100 may display whether a phone call is possible during driving and other driving regulations.

In addition, the AVN terminal 100 may display U-turn with caution and left/right turn streets. In addition, the AVN terminal 100 may display roads, entry to which is prevented due to, e.g., streetcars in Europe. In addition, the AVN terminal 100 may provide path learning software with regard to complex paths including, e.g., high-level roads. In addition, the AVN terminal 100 may display fines and penalties in a case of violations of major laws. In addition to the above-described example, the AVN terminal 100 may display various other information to the user.

Accordingly, the above detailed description is not intended to be construed to limit the present disclosure in all aspects and be considered by way of example. The scope of the present disclosure should be determined by reasonable interpretation of the accompanying claims and all equivalent modifications made without departing from the present disclosure should be included in the following claims.

As is apparent from the above description, according to embodiments of the present disclosure, when a language set in an AVN terminal differs from a pre-defined language that is used in an area including a current position of a vehicle, traffic laws of the corresponding area may be shown in the set language to a user, which may result in improved user convenience.

It will be appreciated by persons skilled in the art that the effects that can be achieved through the present disclosure are not limited to what has been particularly described hereinabove and other advantages of the present disclosure will be more clearly understood from the above detailed description.

It will be apparent to those skilled in the art that various modifications and variations can be made in the embodiments herein without departing from the spirit or scope of the disclosure. Thus, it is intended that the present disclosure covers modifications and variations, provided they come within the scope of the appended claims and their equivalents.

What is claimed is:

1. An audio-video-navigation (AVN) terminal comprising:
a display;
a position information reception unit configured to receive position information of a vehicle including a current position of the vehicle; and
a controller configured to display, via the display, traffic laws of an area including the current position of the vehicle in a language set of the AVN terminal when the language set of the AVN terminal does not correspond to a predefined language related to the area.

2. The AVN terminal according to claim 1, wherein:
the position information reception unit is further configured to receive global positioning system (GPS) position information, and
the controller is further configured to determine the current position of the vehicle based on the GPS position information received by the position information reception unit.

3. The AVN terminal according to claim 1, wherein:
the predefined language related to the area including the current position of the vehicle includes a plurality of languages, and
the controller is further configured to determine whether the language set of the AVN terminal corresponds to any of the plurality of languages.

4. The AVN terminal according to claim 1, wherein the controller is further configured to update the traffic laws of the area, written in at least one language providable by the AVN terminal, received from an external telematics center.

5. The AVN terminal according to claim 4, wherein the controller is further configured to update the traffic laws of the area in real-time or at a predetermined time interval.

6. The AVN terminal according to claim 1, wherein the controller is further configured to display, via the display, the traffic laws of the area in a pop-up window form.

7. The AVN terminal according to claim 1, wherein the controller is further configured to display, via the display, a pop-up window requesting a passenger to provide the traffic laws of the area and to display, via the display, the traffic laws of the area when the passenger agrees to provide the traffic laws.

8. The AVN terminal according to claim 1, wherein the controller is further configured to display, via the display, area characteristic information of the area in the language set of the AVN terminal.

9. The AVN terminal according to claim 8, wherein the area characteristic information includes at least one of:
weather information, tourism information, disaster information, shopping information, and promotion information related to the area.

10. The AVN terminal according to claim 9, wherein the controller is further configured to display, via the display, a still image or moving image corresponding to at least one of: weather information, tourism information, disaster information, shopping information, and promotion information related to the area.

11. The AVN terminal according to claim 1, further comprising an audio module,
wherein the controller is further configured to audibly output, via the audio module, the traffic laws of the area in the language set of the AVN terminal.

12. The AVN terminal according to claim 11, wherein the controller is further configured to audibly output, via the audio module, the area characteristic information of the area in the language set of the AVN terminal.

13. The AVN terminal according to claim 1, wherein the controller is further configured to display, via the display, a still image or moving image corresponding to the traffic laws.

14. A control method of an AVN terminal comprising:
receiving position information of a vehicle regarding a current position of the vehicle; and
displaying traffic laws of an area including the current position of the vehicle in a language set of the AVN terminal when the language set of the AVN terminal does not correspond to a predefined language related to the area.

15. The control method according to claim 14, wherein the receiving of the position information comprises:
receiving global positioning system (GPS) position information, and
determining the current position of the vehicle based on the GPS position information.

16. The control method according to claim 14, wherein:
the predefined language related to the area including the current position of the vehicle includes a plurality of languages, and
the displaying of the traffic laws of the area comprises determining whether the language set of the AVN terminal corresponds to any of the plurality of languages.

17. The control method according to claim 14, further comprising updating the traffic laws of the area, written in at least one language providable by the AVN terminal, received from an external telematics center.

18. The control method according to claim 14, further comprising displaying the traffic laws of the area in a pop-up window form.

19. The control method according to claim 14, wherein the displaying of the traffic laws of the area comprises:
displaying a pop-up window requesting a passenger to provide the traffic laws of the area, and
displaying the traffic laws of the area when the passenger agrees to provide the traffic laws.

20. A non-transitory computer readable medium containing program instructions for performing a control method of an AVN terminal comprising:
program instructions that receive position information of a vehicle regarding a current position of the vehicle; and
program instructions that display traffic laws of an area including the current position of the vehicle in a language set of the AVN terminal when the language set of the AVN terminal does not correspond to a predefined language related to the area.
